(19) United States
(12) Patent Application Publication
(10) Pub. No.: US 2016/0224621 A1
(43) Pub. Date: Aug. 4, 2016

(54) Associating A Search Query With An Entity

(71) Applicant: Google Inc., (US)

(72) Inventors: Olivier Jean Andre Bousquet, Zurich (CH); Oskar Sandberg, Zurich (CH); Sylvain Gelly, Olten (CH); Randolph Gregory Brown, Sunnyside, NY (US)

(73) Assignee: Google Inc., Mountain View, CA (US)

(21) Appl. No.: 13/801,795

(22) Filed: Mar. 13, 2013

Related U.S. Application Data
(63) Continuation of application No. 13/800,689, filed on Mar. 13, 2013, now abandoned.

(51) Int. Cl. G06F 17/30

(52) U.S. Cl. CPC G06F 17/30424

(57) ABSTRACT

Methods and apparatus for associating a search query with at least one entity. Some implementations are directed to methods and apparatus for identifying one or more entities associated with search result documents responsive to a query, and associating one or more of the entities with the query. Some implementations are directed to methods and apparatus for identifying one or more entities associated with a query and providing information related to the entities in response to the query. Associated entities and/or data associated with associated entities for a given query may be provided to one or more users and/or stored for later retrieval.

### CROSS REFERENCE TO RELATED APPLICATIONS

This application is a continuation under 35 U.S.C. §120 of U.S. patent application Ser. No. 13/800,689, filed Mar. 13, 2013, and entitled “Associating a Search Query with an Entity”, which is incorporated by reference herein in its entirety.

### BACKGROUND

This specification is directed generally to digital information retrieval and, particularly to associating a search query with at least one entity.

Internet search engines provide information about Internet accessible documents such as web pages, images, text documents, and/or multimedia content. A search engine may identify the documents in response to a user's search query that includes one or more search terms and/or phrases. The search engine ranks the documents based on the relevance of the documents to the query and the importance of the documents and provides search results that link to the identified documents. The search results may be presented to the user in an order that is based on the rank of the search results. The rank of each search result may be based on a score assigned to the search result based on one or more scoring functions.

### SUMMARY

The present disclosure is directed to methods and apparatus for associating a search query with at least one entity. For example, some implementations are directed to methods and apparatus for identifying one or more entities associated with search result documents responsive to a query, and associating one or more of the identified entities with the query. Also, for example, some implementations are directed to methods and apparatus for identifying one or more entities associated with a query and providing information related to the entities in response to the query. For example, some implementations may provide a query suggestion for a received query. The query suggestions may include an entity descriptor based on an entity associated with the received query and/or the query suggestion. Also, for example, some implementations may provide one or more entity summaries for a received query, with each of the entity summaries including information about one of the identified entities associated with the query. Associated entities and/or data associated with associated entities (e.g., entity scores, entity descriptors, entity summaries) for a given query may be provided to one or more users and/or stored for later retrieval.

In some implementations a computer implemented method may be provided that includes the steps of: receiving a query; identifying a plurality of entities associated with the query based on a query to entity mapping; and providing a plurality of query suggestions for the query, each of the query suggestions based on the query and including an entity descriptor based on one of the entities associated with the query.

This method and other implementations of technology disclosed herein may each optionally include one or more of the following features.

The method may further include identifying a ranking of the entities and ranking the query suggestions based on the ranking of the entities. The ranking of the entities may be based on relationship between the query and search result documents responsive to the query and associated with the entity, and based on the relationship between the entity and the search result documents associated with the entity.

The entity descriptor may include at least one property of the entity. The at least one property of the entity may include an entity type of the entity, a trusted name of the entity, and/or an image of the entity.

The method may further include receiving a user selection of a selected query suggestion of the query suggestions and issuing a search for a search query in response to the user selection, the search query based on the selected query suggestion. The search query may include the entity descriptor of the selected query suggestion. The search query may include at least one property of the entity. The query may be a partial query.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein analyze one or more aspects of a query and/or documents identified in response to a query to create an association between the query and one or more entities. These associations represent new aspects of queries and entities that may be derived from a submitted query and one or more of the documents identified based on the submitted query. The associations may be utilized by one or more applications, such as a search system and/or a query suggestion system, to provide improved search results to users of the applications.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 illustrates a block diagram of an example environment in which a query may be associated with at least one entity; one or more entity summaries for a query may be provided; and/or a query suggestion based on a query to entity association may be identified.

FIGS. 2A, 2B, and 2C illustrate example graphical user interfaces for displaying search results in response to a query; the search results include entity summaries.

FIG. 3 is a flow chart illustrating an example method of associating one or more entities with a query.

FIG. 4 is a flow chart illustrating an example method of identifying one or more entities associated with a query and providing one or more entity summaries for the query.

FIG. 5 is a flow chart illustrating an example method of identifying one or more entities associated with a query and providing a query suggestion for a received query based on the one or more entities associated with the query.

FIG. 6 illustrates an example graphical user interface for displaying a query suggestion that includes an entity descriptor.

FIG. 7 illustrates an example architecture of a computer system.

### DETAILED DESCRIPTION

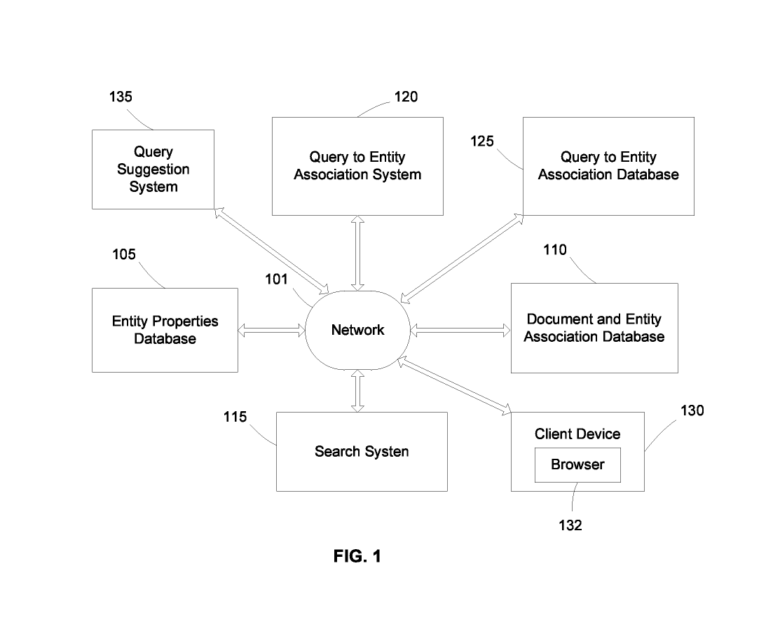

FIG. 1 illustrates a block diagram of an example environment in which a query may be associated with at least one entity. In some implementations entities are topics of discourse. In some implementations, entities are persons, places, concepts, and/or things that can be referred to by a text fragment (e.g., a term or phrase) and are distinguishable from one another (e.g., based on context). For example, the text “bush” on a webpage may potentially refer to multiple entities such as President George Herbert Walker Bush, President George Walker Bush, a shrub, and the rock band Bush. Also, for example, the text “sting” may refer to the musician Gordon Matthew Thomas Sumner or the wrestler Steve Borden.

In some implementations an entity may be referenced by a unique entity identifier that may be used to identify the entity. The unique entity identifier may be associated with one or more properties associated with the entity. For example, in some implementations the entity properties database 105 may include properties associated with unique identifiers of one or more entities. For example, a unique identifier for the entity associated with the wrestler Steve Borden may be associated with a name or alias property of “Sting”, another alias property of “Steve Borden”, an occupation property of “wrestler”, and/or a birthdate property of “March 20, 1959” in the entity properties database 105. Additional and/or alternative properties may be associated with an entity in one or more databases such as entity properties database 105. In some examples in this specification, an entity may be referenced with respect to a unique entity identifier. In some examples, the entity may be referenced with respect to one or more alias and/or other property of the entity.

The example environment of FIG. 1 includes a client device 130, the entity properties database 105, a document and entity association database 110, a search engine 115, a query to entity association system 120, a query to entity association database 125, and a query suggestion system 135. The environment also includes a communication network 101 that enables communication between various components of the environment. In this specification, the term “database” will be used broadly to refer to any collection of data. The data of a database does not need to be structured in any particular way, or structured at all, and it can be stored on storage devices in one or more locations. Thus, for example, the entity properties database 105 may include multiple collections of data, each of which may be organized and accessed differently.

In some implementations the entity properties database 105 may include a database of structured data that includes nodes that represent entities and identifies the type of each entity represented by a node. A node representing an entity may also be associated with metadata in the database of structured data (e.g., via links that represent properties of the entity). Any included metadata may include, for example, names/aliases for the entity, resource locators of resources that are about the entity, descriptive information about the entity, among other data. Each node in the online database of structured data may be associated with an entity identifier for the entity that can be used to identify the entity and that optionally remains constant. For example, if a person represented by a node changes their legal name, a unique identifier for the node representing the person may remain constant while the metadata that identifies the person's legal name can be changed to reflect the change to the person's legal name.

In some implementations the entity properties database 105 may include links between nodes and data that identifies the relationship between entities represented by linked nodes. An example of an online database of structured data that exists is the FREEBASE database. Other sources may include online encyclopedias having pages directed to each of a group of entities and websites directed to particular types of entities (e.g., actors, directors, producers, politicians, sports stars). Other sources may also include one or more database of structured data that is not freely accessible online. As discussed herein, in some implementations the entity properties database 105 may be utilized by the search system 115, the query to entity association system 120, and/or the query suggestion system 135.

The query to entity association database 125 may include an index of queries and associated entities. For example, for each query, a mapping (e.g., data defining an association) between the query and one or more entities related with the query may be identified in the query to entity association database 125. In some implementations the query to entity association database 125 may be utilized by the search system 115, the query suggestion system 135, and/or one or more additional and/or alternative components. For example, in some implementations, the search system 115 may identify one or more entities associated with a received query and provide information related to the entity as part of the search results. For example, an entity associated with a received search query may be identified via the query to entity association database 125 and an entity summary that includes information about the entity may be provided along with the search results. For example, the musician Gordon Matthew Thomas Sumner may be associated with the query “sting” in the query to entity association database 125. In response to a received query “sting”, the search system 115 may identify the musician Gordon Matthew Thomas Sumner from the query to entity association database 125 and provide information related to the musician Gordon Matthew Thomas Sumner (e.g., an image, a discography, an alias, and/or a birthdate). Any provided entity summary may be provided as the sole search result and/or in addition to other search results responsive to the query. In some implementations the search system 115 may perform one or more of the steps of the method of FIG. 4.

In some implementations one or more aspects of the information about the entity may be obtained from the entity properties database 105. For example, in some implementations the query to entity association database 125 may associate only one or more unique entity identifiers of one or more entities with a given query and one or more properties of the entities may be obtained from the entity properties database 105 based on the unique entity identifiers. In some implementations one or more properties of the entity may be obtained from the query to entity association database 125 itself. For example, the query to entity association database may 125 associate a given query with one or more entity properties such as properties to be provided in entity summaries for that entity and/or that query.

Also, for example, in some implementations, the query suggestion system 135 may identify one or more entities associated with a received query via the query to entity association database 125. The query suggestion system 135 may provide one or more query suggestions based on the identified entities, with each of the query suggestions being particularly formulated to focus on a particular entity. For example, the musician Gordon Matthew Thomas Sumner and the wrestler Steve Borden may be associated with the query “sting” in the query to entity association database 125. In response to a received query “sting”, the query suggestion system 135 may identify the musician Gordon Matthew Thomas Sumner as the dominant entity from the query to entity association database 125 and suggest an alternative query suggestion to the user, with the alternative query suggestion being particularly formulated for the musician Gordon Matthew Thomas Sumner (e.g., “sting musician”).

Also, for example, the query suggestion system 135 may identify multiple entities associated with a received query via the query to entity association database 125 and the query suggestion system 135 may suggest alternative query suggestions based on the identified multiple entities. Each of the alternative query suggestions may be particularly formulated for a given of the multiple entities. For example, both the musician Gordon Matthew Thomas Sumner and the wrestler Steve Borden may be associated with the query “sting” in the query to entity association database 125. In response to a received query “sting”, the query suggestion system 135 may identify both the musician Gordon Matthew Thomas Sumner and the wrestler Steve Borden from the query to entity association database 125 and suggest two alternative query suggestions, with each being particularly formulated for one of the entities. For example, the query suggestion system 135 may provide a first query suggestion of “sting musician” and a second query suggestion of “sting wrestler.”

In some implementations the query suggestion system 135 may provide a query suggestion to a user and, if the user chooses the query suggestion, may submit a query that strictly conforms to the provided query suggestion. For example, if the provided query suggestion is “sting musician” and the user chooses that query suggestion, a query of “sting musician” may be submitted to the search system 115. In some implementations the query suggestion system 135 may provide a query suggestion to a user and, if the user chooses the query suggestion, may submit a query that pertains to the chosen query suggestion, but does not strictly conform to the provided query suggestion. For example, if the provided query suggestion is “sting musician” and the user chooses that query suggestion, a query of “sting Gordon Sumner” may be submitted to the search system 115.

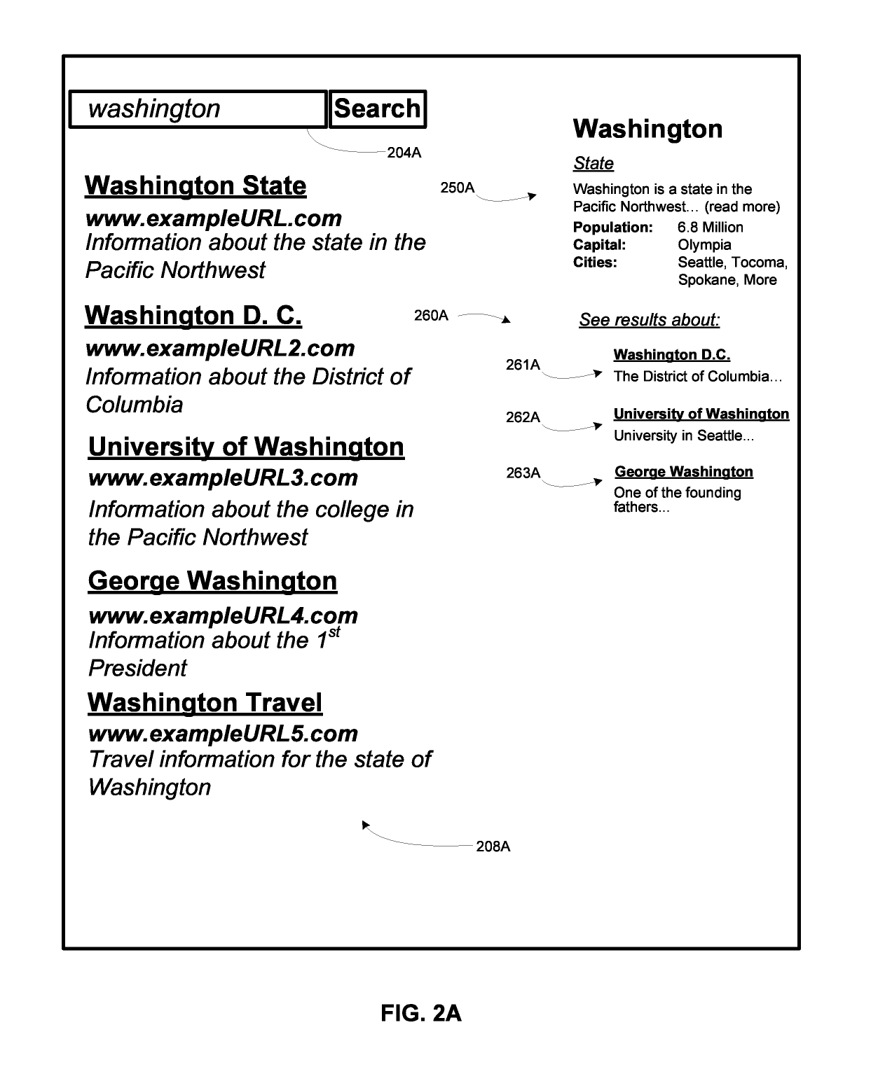

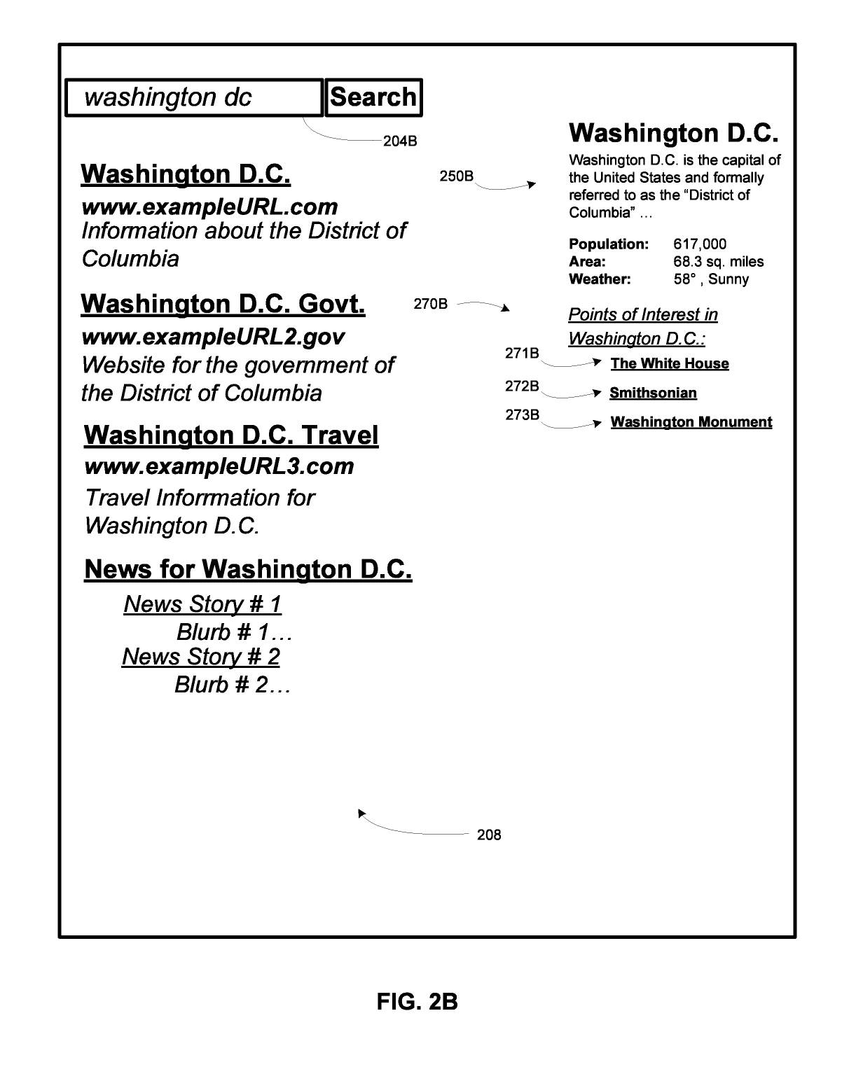

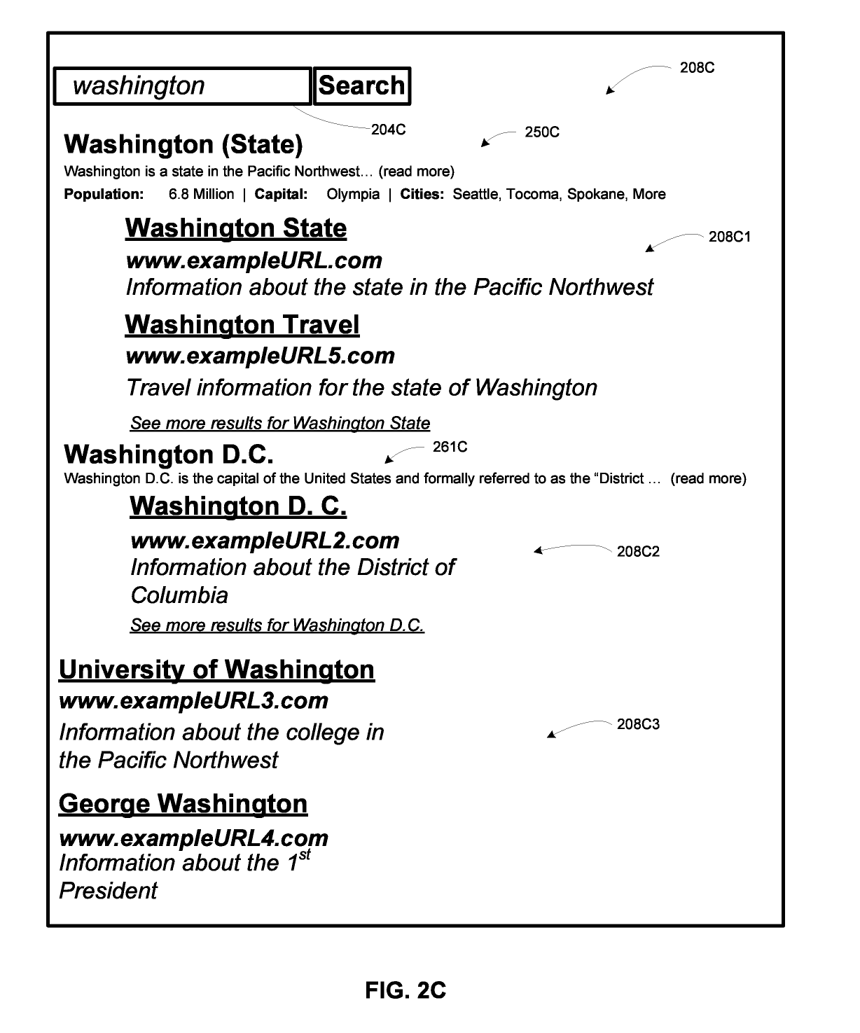

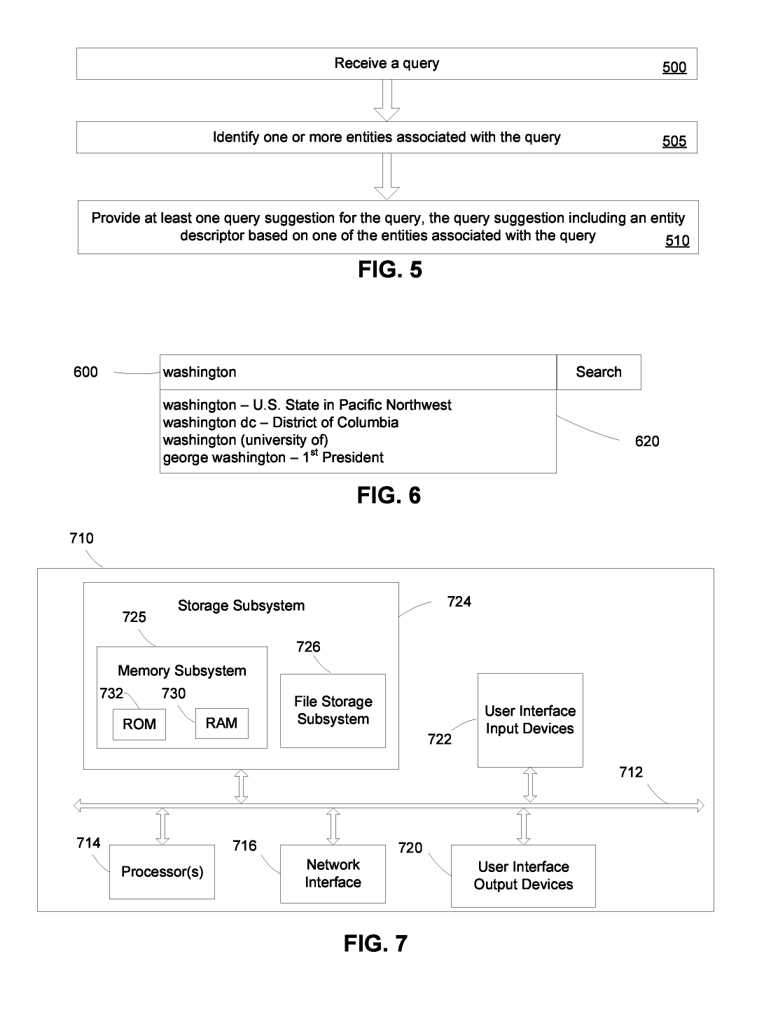

In some implementations the query suggestion system 135 may provide suggested queries for display with search results. For example, suggested queries may be provided in combination with search results such as search results of FIGS. 2A-2C. In some implementations the query suggestion system 135 may provide query suggestions for display in and/or adjacent to a search field. For example, the query suggestion system 135 may provide query suggestions as a user is formulating a query as illustrated, for example, in FIG. 6. In some implementations the query suggestion system 135 may perform one or more of the steps of the method of FIG. 5.

In some implementations one or more aspects of a provided query suggestion and/or a submitted search query based on a provided query suggestion may be obtained from the entity properties database 105. For example, in some implementations the query suggestion system 135 may associate only one or more unique entity identifiers of one or more entities with a given query and one or more properties of the entities provided in a provided query suggestion and/or included in a submitted search query based on the provided query suggestion may be obtained from the entity properties database 105 based on the unique entity identifiers. For example, in response to a received query “sting”, the query suggestion system 135 may identify the musician Gordon Matthew Thomas Sumner from the query to entity association database 125 and suggest one alternative query suggestion of “sting musician”. The alternative query suggestion of “sting musician” may be identified based on the entity properties database 105. For example, in some implementations properties (e.g., “musician”) associated with an entity in the entity properties database 105 may be ranked and one or more of the highest ranked properties may be appended to the query to create an alternative query suggestion.

In some implementations one or more aspects of the information about the entity may be obtained from the query to entity association database 125 itself. Also, for example, in some implementations the query to entity association database 125 may associate each entity associated with a given query with a query suggestion and/or a search query for the entity. For example, for the query “sting”, the entity identifier for the wrestler Steve Borden may be associated with a query suggestion of “sting wrestler” and associated with a search query of “sting steve borden”. Accordingly, in response to the query “sting” the query suggestion of “sting wrestler” may be provided to the user and, upon selection of “sting wrestler” by the user, the search query “sting steve borden” may be submitted to the search system 115.

In some implementations one or more aspects of any search query associated with a given entity may be obtained from an entity to query association database. An entity to query association database may associate each of a plurality of entities with one or more entity search queries that provide desired search results specific to the entity. For example, an entity to query association database may associate the musician Gordon Matthew Thomas Sumner with the entity search query “sting musician”. In some implementations the provided query suggestion may additionally and/or alternatively be obtained from the entity to query association database. For example, in some implementations the provided query suggestion may be the same as the search query submitted in response to user selection of the query suggestion. In some implementations the provided query suggestion may be obtained from the entity properties database 105 and the search query submitted in response to selection of the query suggestion may be obtained from the entity to query association database.

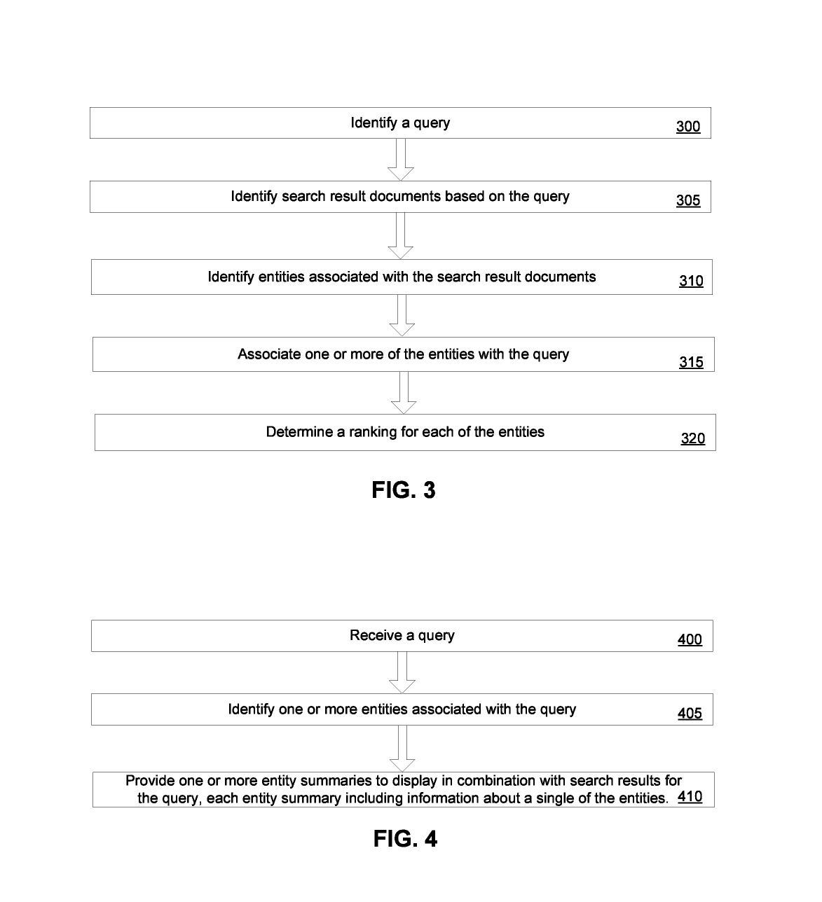

In some implementations associations between queries and entities in query to entity association database 125 may be identified via query to entity association system 120. For example, in some implementations query to entity association system 120 may perform one or more steps of the method of FIG. 3 in associating entities with queries. In some implementations the query to entity association database 125 may be omitted. For example, in some implementations an association between a received query and one or more entities may be determined upon receipt of the query and may not be stored in a database such as query to entity association database 125 for future retrieval.

The document and entity association database 110 may include an index of documents and associated entities. For example, for each of a plurality of documents, a mapping (e.g., data defining an association) between the document and one or more entities related with the document may be identified in the document and entity association database 110. A document is any data that is associated with a document address. Documents include HTML pages, word processing documents, portable document format (PDF) documents, images, video, and feed sources, to name just a few. The documents may include content such as, for example: words, phrases, pictures, etc.; embedded information (such as meta information and/or hyperlinks); and/or embedded instructions (such as JavaScript scripts).

In some implementations the document and entity association database 110 may be accessible to the query to entity association system 120 in determining associations between a given query and one or more entities associated with the query. For example, in some implementations, the query to entity association system 120 may associate an entity with a given query based on association of the entity with one or more documents that are responsive to a search based on the query. In some implementations an association between a document and an entity may be based on presence of one or more properties of the entity in the document. For example, an association between a document and an entity may be based on an importance of one or more alias of the entity in the document. For example, appearance of an alias of an entity in important fields and/or with great frequency in a document may be indicative of association of the entity to the document. Also, for example, an association between a document and an entity may be based on presence of additional and/or alternative properties of an entity such as date of birth, place of birth, height, weight, population, geographic location(s), type of entity (e.g., person, actor, location, business, university), etc.

In some implementations an association between a document and an entity may be based on presence in the document of one or more other entities related the entity. For example, links between entities may be identified from a database such as entity properties database 105. For example, the entity properties database 105 may include spouse information for an entity and an association between a document and a person may be based on occurrence of a spouse of the person in the document. For example, if a person's alias is ambiguous, presence of an alias of the person's spouse in a document along with the person's alias may be more indicative of the person being associated with the document than if the person's alias appeared in the document without the alias of the person's spouse. Also, for example, an association between a document and an entity may be based on presence of additional and/or alternative entities associated with a given entity, such as co-workers, co-stars, similar types of businesses, etc.

Additional and/or alternative factors may be utilized in associating a document with one or more entities. For example, in some implementations one or more users may provide input to associate a document with one or more entities.

In some implementations a user may interact with the search system 115 through a client computing device 130. The computing device 130 may be, for example, a desktop computer, a laptop computer, a cellular phone, a smartphone, a personal digital assistant (PDA), a tablet computer, a navigation system, or another computing device. The computing device 130 and the search system 115 each include memory for storage of data and software applications, a processor for accessing data and executing applications, and components that facilitate communication over a communication network 101. The operations performed by the client computing device 130 and/or the search system 115 may be distributed across multiple computer systems.

The computing device 130 executes one or more applications, such as web browsers (e.g., web browser 132), that enable the user to formulate queries and submit completed queries to the search system 115. In some implementations queries may be submitted directly to the search system 115 from the computing device 130. In some implementations queries may be submitted from the query to entity association system 120 and/or other component to the search system 115.

The search system 115 is an example of an information retrieval system in which the systems, components, and techniques described herein may be implemented and/or with which the systems, components, and techniques described herein may interface. The search system 115 receives queries from the client device 130 and/or other component (e.g., query to entity association database 120) and returns results in response to the queries. For example, in response to a query from the computing device 130, the search system 115 may transmit a plurality of search results to be displayed in the web browser 132 that is executing on the computing device 130. Each query is a request for information. The query can be, for example, in a text form and/or in other forms such as, for example, audio form and/or image form. Other computer devices may submit search queries to the search system 115 such as a server implementing a service for a website that has partnered with the provider of the search system 115. For brevity, however, the examples are described in the context of the client device 130, the query to entity association system 120, and/or the query suggestion system 135.

While the search system 115 and the client device 130 are shown as two separate devices, in some implementations the search system 115 and the client device 130 may be the same device. For example, in some implementations a user may install a desktop search application on the client device 130. The search system 115 may be implemented as, for example, computer programs running on one or more computers in one or more locations that are coupled to each other through a network.

In some implementations, as described herein, the query to entity association system 120 and/or the query suggestion system 135 may additionally interact with the search system 115. For example, as described with respect to the method of FIG. 3, in some implementations the query to entity association system 120 may interface with the search system 115 in associating one or more of the entities with a query based on the entity score. For example, in some implementations the query to entity association system 120 may interface with the search system 115 to identify search result documents based on a query and/or to rank the entities associated with one or more of the search result documents.

The search system 115 may include an indexing engine and a ranking engine. The indexing engine maintains an index for use by the search system 115. The indexing engine processes documents and updates index entries in the index, for example, using conventional and/or other indexing techniques.

The ranking engine uses the index to identify documents responsive to a submitted query, for example, using conventional and/or other information retrieval techniques. The ranking engine calculates scores for the documents responsive to the query, for example, using one or more ranking signals. Each signal provides information about the document itself and/or the relationship between the document and the query. One example signal is a measure of the overall quality of the document. Another example signal is a measure of the number of times the terms of the query occur in the document. Additional and/or alternative signals can also be used.

For example, additional and/or alternative signals include information about the query itself such as, for example, the terms of the query, an identifier of the user who submitted the query, and/or a categorization of the user who submitted the query (e.g., the geographic location from where the query was submitted, the language of the user who submitted the query, interests of the user who submitted the query, and/or a type of the client device 130 used to submit the query (e.g., mobile device, laptop, desktop)). The identification of the user can be, for example, a user name or the IP address of the client device 130. The geographic location from where the query was submitted can be, for example, a continent, a country, a state, a city, or geographic coordinates, such as latitude and longitude.

Signals may also include information about the terms of the query such as, for example, the locations where a query term appears in the title, body, and text of anchors in a document, where a query term appears in anchors pointing to the search result, how a term is used in the document (e.g., in the title of the document, in the body of the document, or in a link in the document), the term frequency (i.e., the number of times the term appears in a corpus of documents in the same language as the query divided by the total number of terms in the corpus), and/or the document frequency (i.e., the number of documents in a corpus of documents that contain the query term divided by the total number of documents in the corpus).

Further examples of signals include information about the document, for example, a measure of the quality of the document, a measure of the popularity of the document, the URL of the document, the geographic location where the document is hosted, when the search system 115 first added the document to the index database, the language of the document, the size of the document, the length of the title of the document, and/or the length of the text of source anchors for links pointing to the document.

The ranking engine then ranks the responsive documents using the scores. For example, the responsive documents are ranked based on the scores. In some implementations information pertaining to one or more of the responsive documents, the scores of the one or more responsive documents, and/or the rankings of the one or more responsive documents may be provided to query to entity association system 120 for use in associating one or more entities with a query. The search system 115 uses the documents identified and scored by the ranking engine to generate results. The results include results corresponding to documents responsive the query. For example, results can include titles of each of the documents, links to each of the documents, and/or a summary of content from each of the documents that is responsive to the query. For example, the summary of content may include a particular “snippet” or section of one or more documents that is responsive to the query.

Other examples of results include a summary of information responsive to the query. The summary can be generated from documents responsive to the query and/or from other sources. For example, in some implementations the summary can be generated based on identification of one or more entities associated with a submitted query. For example, in some implementations the search system 115 may identify an entity associated with a query via consultation of query to entity association database 125. In response to the query, results may be provided that include a summary of the entity. For example, the entity and/or one or more properties of the entity may be provided as a result. In some implementations one or more properties of the entity may be retrieved from entity properties database 105.

The results are transmitted to the client device 130 in a form that may be provided to the user. For example, the results 130 may be transmitted as a search results web page to be displayed on a browser running on the client device and/or as one or more search results conveyed to a user via audio.

The one or more applications executing on the computing device 130 may additionally and/or alternatively provide partial queries being formulated by users, before the users have indicated completion of the queries. The applications may be, for example, a web browser, a toolbar running in a web browser, an e-mail application, a text-messaging application, and/or a search client running on the computing device 130. In some implementations the applications provide each character of a query as it is typed or otherwise entered by the user. In some implementations the applications provide multiple characters at a time, optionally following a pause by the user between character entries.

A partial query is a query formulated by a user prior to an indication by the user that the query is a completed query. In some implementations a user may indicate a completed query by entering a carriage return and/or other character. In some implementations a user may indicate a completed query by selecting a search button or other submission button in a user interface presented to the user. In some implementations a user may indicate a completed query by speaking a command in a speech user interface. In some implementations a user may indicate a completed query by pausing more than a predetermined amount of time during entering of the query. Other forms of providing a partial query and/or indicating a completed query may additionally and/or alternatively be utilized.

In response to a partial query entered by a user, the computing device 130 may facilitate entry of user input by providing suggested inputs to the user. For example, when the user enters one or more characters, the computing device 130 can provide autocomplete query suggestions that are selected using the one or more characters. In some implementations the autocomplete query suggestions may be provided to the computing device 130 by query suggestion system 135. The autocomplete query suggestions that are provided may include words or phrases that include the one or more characters that were entered by the user. For example, complete words or extended phrases can be suggested for partial words or partial phrases that a user has entered (e.g., using a physical or virtual keyboard). The autocomplete query suggestions can also include words or phrases that are similar to (e.g., synonyms or spelling corrections of) the user input. The user can interact with (e.g., tap, click, or otherwise affirmatively select) one of the provided autocomplete query suggestions to select the autocomplete query suggestion.

In some implementations, the computing device 130 does not initiate a search using the query in response to a selection of an autocomplete query suggestion. Rather, the computing device 130 can wait to initiate a search until query completion data is received. The query completion data can indicate that the user has finished composing a complete query. The query completion data can be received as an interaction with a user interface element that occurs separate from the selection of an autocomplete query suggestion.

The autocomplete query suggestions may be displayed to a user in a user interface of the computing device 130. For example, the autocomplete query suggestions may be displayed as illustrated in FIG. 6 within a cascaded drop down menu of the search field of an application, such as a web browser executing on the computing device 130, as the user is typing the query. Also, for example, the autocomplete query suggestions may be displayed in a plurality of separately selectable cells arranged in one or more rows or columns in a user interface as the user is typing the query. In some implementations one or more search results for a query suggestion may also optionally be displayed as the user is typing the query.

In some implementations, in response to a partial query being entered at computing device 130, the search system 115 receives the partial query and forwards the partial query to the query suggestion system 135. In some implementations, in response to a partial query being entered at computing device 130, the one or more applications executing on the computing device 130 may optionally directly forward the partial query to the query suggestion system 135. For example, in some implementations the browser 132 may directly forward the partial query to the query suggestion system 135. The query suggestion system 135 includes memory for storage of data and software applications, a processor for accessing data and executing applications, and components that facilitate communication over the communication network 101. The query suggestion system 135 may then match the submitted partial query to one or more of a plurality of autocomplete query suggestions that are an appropriate match to the partial query. In some implementations the autocomplete query suggestions may represent potential completed queries that may be provided to a user to enable the user to choose one of the autocomplete query suggestions as a basis for utilization in a search or other information retrieval application.

As discussed herein, in some implementations one or more of the provided autocomplete query suggestions may be determined via the query to entity association system 120 and/or the query to entity association database 125. For example, in some implementations one or more of the autocomplete query suggestions may include an entity descriptor that is based on an identified entity associated with the query and/or a query suggestion for the query. For example, each of the autocomplete query suggestions for the partial query “washington” in FIG. 6 is provided with an entity descriptor. The entity descriptor may be based on identification of one or more entities associated with the autocomplete query suggestion as determined via query and entity suggestions system 120 and/or query to entity association database 125. In some implementations the autocomplete query suggestions may include those determined based on a list of past user queries, a list of automatically generated queries, and/or real time automatically generated queries. For example, the query suggestion system 135 may use prefix based matching to identify query suggestions from a list of past user queries. Any listing of past user queries and/or past automatically generated queries may optionally be stored in an autocomplete query suggestion content database, for potential utilization as query suggestions and/or as a basis for query suggestions. Any entity annotations of the autocomplete query suggestions may also optionally be stored and/or determined via query to entity association system 120 and/or query to entity association database 125.

As discussed herein, in some implementations the autocomplete query suggestions may include an entity descriptor that identifies a particular entity associated with the autocomplete query suggestion. In some implementations the entity descriptor may be included in a search query submitted in response to selection of the autocomplete suggestion. In some implementations the submitted search query may omit the entity descriptor. In some implementations the provided autocomplete query suggestion and the query submitted in response to user selection of the autocomplete query suggestion may differ. For example, in some implementations the autocomplete query suggestion may be “sting wrestler” and selecting that autocomplete query suggestion may lead to submission of the search query “sting borden wrestler”.

In some implementations any provided autocomplete query suggestion content database may include one or more autocomplete query suggestions that have been determined, scored, and/or sorted according to one or more methods and/or apparatus described herein. For example, the autocomplete query suggestion content database may include one or more autocomplete query suggestions that have been determined, scored, and/or sorted based on one or more entities associated with the autocomplete query suggestion and/or one or more entities responsive to a partial query for which the autocomplete query suggestion is responsive. For example, for the partial query “sting” autocomplete query suggestions of “sting wrestler” and/or “sting musician” may be determined, scored, and/or sorted based on identification of association between the query “sting” and entities for the wrestler Sting and the musician Sting. Also, for example, for the partial query “stin” (no “g”) autocomplete query suggestions of “sting wrestler” and/or “sting musician” may be determined, scored, annotated and/or sorted based on identification of association between an autocomplete suggestion of “sting” (suggestion for “stin”) and entities for the wrestler Sting and the musician Sting.

Such autocomplete query suggestions may be provided to a user. In some implementations the query suggestion system 135 may provide the autocomplete query suggestions to a user via the search system 115, the query to entity association system 120, and/or to the computing device 130 directly.

In some implementations the query suggestion system 135 may transmit the determined additional autocomplete query suggestions, determined scores for one or more of the autocomplete query suggestions, and/or the ranking of the autocomplete query suggestions for storage in a database. In some implementations stored data may optionally be associated with a corresponding query in the database for future retrieval in response to a future autocomplete query suggestion request for the query. In some implementations the query suggestion system 135 may identify existing autocomplete query suggestions for a given partial query to enable determination of additional autocomplete query suggestions and/or annotations for storage in a database for future retrieval. In some implementations the query suggestion system 135 may supply autocomplete query suggestions associated with an entity for a real time query.

In some implementations the query suggestion system 135 provides autocomplete query suggestions to a user. In some implementations the query suggestion system 135 may provide the autocomplete query suggestions to a user via the search system 115, the query suggestion system 135, and/or to the computing device 130 directly.

In some implementations the search system 115 and/or the computing device 130 may optionally additionally or alternatively provide a completed query to the query suggestion system 135. A completed query is a query that the user has indicated is complete. The autocomplete query suggestion engine 110 may then match the completed query to one or more autocomplete query suggestions to determine one or more query suggestions for the user's completed query. The query suggestion system 135 then provides these query suggestions to the user. The query suggestions may, for example, be embedded within a search results web page to be displayed in an application, such as the web browser 132, as potential further search options.

The communication network 101 facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques.

Many other configurations are possible having more or less components than the environment shown in FIG. 1. For example, although the query to entity association system 120 and the search system 115 are each illustrated alone in FIG. 1, it is understood that one or more aspects of two or more of the systems may optionally be combined with one another and/or with aspects of one or more of the other components in some implementations. Also, for example, in some implementations one or more components may be omitted such as query suggestion system 135 and/or entity properties database 105.

FIGS. 2A, 2B, and 2C illustrate example graphical user interfaces for displaying search results in response to a query. The illustrated graphical user interfaces include one or more entity summaries incorporated therewith. The entity summaries include one or more properties of an entity associated with the respective queries. As discussed herein, the properties may be obtained, for example, from the entity properties database 105 and/or the query to entity association database 125. The entity summaries and/or the properties displayed with the entity summaries may optionally be ranked utilizing one or more signals related to the entities, related to the query and/or related to one or more documents responsive to the query. Signals can include, for example, one or more signals such as those described with respect to FIG. 1. Any optionally determined rankings may be utilized to determine which entities are provided in an entity summary, an order of multiple entity summaries, which properties of an entity are provided in an entity summary, and/or an order of multiple properties in an entity summary.

In FIG. 2A the query “washington” 204A is submitted to a search engine, through the graphical user interface, and a set of search results that are responsive to the query 204A are generated by the search engine and presented in the user interface. The search results in FIG. 2A include search results 208A that are based on search result documents responsive to the query. The search results 208A may be ranked according to one or more signals as discussed herein such as document based signals and/or query based signals. The search results in FIG. 2A also include an expanded entity summary 250A for the state of Washington and non-expanded entity summaries 260A. The non-expanded entity summaries include summaries for the entities “Washington D.C.” 261A, the “University of Washington” 262A, and “George Washington” 263A. The expanded entity summary 250A includes more information than each of the entity summaries 260A. The entity summary 250A and/or the entity summaries 261A, 261B, and/or 261C may optionally be selected (e.g., via clicking or hovering over) to navigate to additional information about the respective entity, to provide a more detailed entity summary on the search results page of FIG. 2A (e.g., effectively “expanding” the selected entity summary), and/or to obtain search results that are more focused toward the selected entity (e.g., via issuing a new search specific to that entity and/or filtering the existing search results). For example, selecting the entity summary 250A may issue a new search for the entity associated with “washington state” and search results responsive to that query may be provided. Although specific entity summaries 250A and 260A are illustrated in FIG. 2A, it is understood that additional and/or alternative properties related to an entity may be provided. For example, in some implementations one or more images of an entity and/or related to an entity may be provided in an entity summary.

The entities associated with the entity summaries 250A and 260A may be identified based on association of the query 204A with the entities of the entity summaries 250A and 260A. The association may be determined via query to entity association system 120 and/or query to entity association database 125. In some implementations the entity summaries 250A and 260A may be presented based on a ranking of the respective entities for the query 204A. For example, the state of Washington may be the highest ranked entity followed in order by “Washington D.C.”, “University of Washington”, then “George Washington.” As discussed herein, in some implementations the ranking for an entity may be based on a relationship between the entity and the search result documents associated with the entity and/or a relationship between the query and the search result documents associated with the entity.

In some implementations the expanded entity summary 250A may be expanded based on it being based on the highest ranked entity. In some implementations the expanded entity summary may be expanded based on satisfaction of a threshold relative to the ranking of a second highest ranked entity such as the entity associated with “Washington D.C.”. For example, in some implementations where the ranking is based on a score associated with the entities and a higher score is associated with a higher ranking, the threshold may be satisfied if the score of the highest ranked entity is at least a threshold value larger than the score of the next highest ranked entity. Also, for example, in some implementations where the ranking is based on a score associated with the entities and a higher score is associated with a higher ranking, the threshold may be satisfied if the score of the highest ranked entity is at least a threshold percentage larger than the score of the next highest ranked entity.

In some implementations any score and/or ranking associated with the entities of the entity summaries 250A and 260A may be based on scores associated with the entities by query to entity association system 120 and/or in query to entity association database 125. In some implementations the ranking of the entities may be adjusted and/or determined based on the search result documents associated with search results 208A and/or additional search result documents responsive to the query. For example, in some implementations the entity Washington State may be associated with a score for the query “Washington” in the query to entity association database 125 and the score may be adjusted based on the results 208A. For example, the score may be boosted based on the top ranked search result of the search results 208A being about Washington State and an additional displayed search result (the last displayed search result) also being about Washington State. Ranking of the entities based at least in part on the search results 208A may enable ranking of the entities based on search results that are personalized to the user (e.g., based on user data) and/or to enable ranking of the entities based on fresh search results (e.g., to account for promotion and/or demotion of search results since any prior ranking was determined).

In FIG. 2B the query “washington dc” 204B is submitted to a search engine, through the graphical user interface, and a set of search results that are responsive to the query 204B are generated by the search engine and presented in the user interface. The search results in FIG. 2B include search results 208B that are based on search result documents responsive to the query 204B. The search results 208B may be ranked according to one or more signals as discussed herein such as document centric signals and/or query centric signals. The search results in FIG. 2B also include an entity summary 250B for “Washington D.C.”

The entity summary 250B includes a points of interest listing 270B in which additional properties associated with Washington D.C. are listed. The listed properties include additional entities that are associated with Washington D.C. (e.g., mapped to Washington D.C. in the entity properties database 105). The related entities include “The White House” 271B, “Smithsonian” 272B, and “Washington Monument” 273B. In some implementations the related entities may be selected and/or ordered based on a ranking associated with the related entities. For example, the White House may be the highest ranked entity followed in order by the Smithsonian then the Washington Monument. In some implementations the ranking for properties for an entity, such as related entities, may be based on a relationship between the property and the query and/or a relationship between the property and the search result documents associated with the entity.

For example, in some implementations the points of interest listing 270B may be determined based on satisfaction of a threshold. For example, in some implementations where the ranking is based on a score associated with the properties and a higher score is associated with a higher ranking, the threshold may be satisfied if the score of the property exceeds the score of a threshold value. Although a specific entity summary 250B and points of interest listing 270B are illustrated in FIG. 2B, it is understood that additional and/or alternative properties related to an entity may be provided. For example, in some implementations one or more images of and/or related to an entity and/or one or more related entities may be provided in an entity summary.

The entity summary 250B may be identified based on association of the query 204B with the entity of the entity summary 250B. The association may be determined via query to entity association system 120 and/or query to entity association database 125. In some implementations the entity summary 250B may be presented based on a ranking of the one or more entities for the query 204B.

In some implementations any score and/or ranking associated with the entity of the entity summary 250B and/or the points of interest listing 270B associated with the entity summary 250B and 260A may be based on scores associated with the entities and/or the points of interest by query to entity association system 120 and/or in query to entity association database 125. In some implementations the ranking may be adjusted and/or determined based on the search results 208B and/or additional search results that are based on search result documents responsive to the query. Ranking of the entities and/or the points of interest for one or more given entities based on the search results 208B may enable ranking of the entities based on search results that are personalized to the user (e.g., based on user data) and/or to enable ranking of the entities based on fresh search results (e.g., to account for promotion and/or demotion of search results since any prior ranking was determined).

In FIG. 2C the query “Washington” 204C is submitted to a search engine, through the graphical user interface, and a set of search results that are responsive to the query 204C are generated by the search engine and presented in the user interface. The search results in FIG. 2C include search results 208C that are based on search result documents responsive to the query 204C. The search results 208C are divided into three groupings 208C1, 208C2, and 208C3. The search results 208C1 are grouped under an expanded entity summary 250C for the State of Washington. The search results 208C1 are associated with the entity for the State of Washington. In some implementations the search results 208C1 may be associated with the entity for the State of Washington based on association of the search result documents with which they are associated to the State of Washington in the document and entity association database 110. For example, the primary entity for the search result documents associated with search results 208C1 may be the entity associated with state of Washington. In some implementations the search results 208C1 may be associated with the entity for the State of Washington based on occurrence of one or more properties associated with the entity of the state of Washington in the search results 208C1. For example, the results 208C1 include properties such as “Pacific Northwest” and “state”.

The search result 208C2 is provided under an entity summary 261C for the entity for the District of Columbia. The search result 208C2 is associated with the entity for the District of Columbia. In some implementations the search results 208C1 may be associated with the entity for the District of Columbia based on the document and entity association database 110 and/or occurrence of one or more properties associated with the entity of the District of Columbia in the search result 208C2.

The search results 208C3 are not grouped under an entity summary. The search results 208C3 are not associated with the entity for the District of Columbia or the entity for the State of Washington. Rather, they are primarily associated with separate entities (“the University of Washington” and “George Washington”).

The entity summary 250C and/or the entity summary 261C may optionally be selected (e.g., via clicking or hovering over) to navigate to additional information about the respective entity and/or to provide a more detailed entity summary on the search results page of FIG. 2A (e.g., effectively expanding the selected entity summary). The text “See more results for Washington State” may optionally be selected to obtain additional search results about the entity Washington State. Likewise, the text “See more results for Washington D.C” may optionally be selected to obtain additional search results about the entity Washington D.C. Although specific entity summaries 250C and 261C are illustrated in FIG. 2C, it is understood that additional and/or alternative properties related to an entity may be provided.

The entities associate with the entity summaries 250C and 261C may be identified based on association of the query 204C with the entities of the entity summaries 250C and 261C. The association may be determined via query to entity association system 120 and/or query to entity association database 125. In some implementations the entity summaries 250C and 261C may be presented based on a ranking of the respective entities for the query 204A. In some implementations the expanded entity summary 250C may be expanded based on it being based on the highest ranked entity. In some implementations the expanded entity summary 250C may be expanded based on satisfaction of a threshold relative to the ranking of another ranked entity such as the entity “Washington D.C.”.

In some implementations any score and/or ranking associated with the entities of the entity summaries 250C and 261C may be based on scores associated with the entities by query to entity association system 120 and/or in query to entity association database 125. In some implementations the ranking of the entities may be adjusted and/or determined based on the search results 208C1, 208C2, 208C3, and/or additional search result documents responsive to the query.

While FIGS. 2A-2C show example visual displays of search results, presenting search results can include various forms of presentation including, for example, displaying search results on a display device, transmitting search results to a user's computer for presentation to the user, transmitting search results to another device, transmitting sounds corresponding to the search results, providing haptic feedback corresponding to the search results, and/or transmitting signals comprising haptic feedback corresponding to the search results to a user's computer for presentation to the user.

FIG. 3 is a flow chart illustrating an example method of associating one or more entities with a query. Other implementations may perform the steps in a different order, omit certain steps, and/or perform different and/or additional steps than those illustrated in FIG. 3. For convenience, aspects of FIG. 3 will be described with reference to a system of one or more computers that perform the process. The system may include, for example, the query to entity association system 120 and/or the search system 115 of FIG. 1.

At step 300, a query is identified. In some implementations the search system 115 may receive the query. In some implementations the query to entity association system 120 may receive the query. In some implementations the query may be a query submitted by a user. In some implementations the query may be a query from a log of queries, such as a log of past user queries and/or automatically generated queries.

At step 305, search result documents are identified based on the query received at step 300. For example, in some implementations the query to entity association system 120 may submit the query to the search system 115. The ranking engine of the search system 115 may use the index to identify documents responsive to the query. In some implementations all documents identified by the ranking engine of the search system 115 may be identified at step 305. In some implementations only a subset of documents identified by the ranking engine may be identified at step 305. For example, in some implementations only a certain percent of the total documents may be identified and/or only a certain number of documents may be identified. For example, in some implementations only a certain percent of the documents having the highest ranking may be identified. Ranking may be based on, for example, one or more signals described herein such as document based signals and/or query based signals.

At step 310, entities associated with each of the identified search result documents are identified. For example, in some implementations the query to entity association system 120 may identify the entities based on a database of documents and associated entities such as document and entity association database 110. For example, for each of the identified search result documents, the document and entity association database 110 may be consulted to identify one or more entities associated with the document. In some implementations an association between a document and an entity may be based on presence of one or more properties of the entity in the document. For example, an association between a document and an entity may be based on an importance of one or more alias of the entity in the document. For example, appearance of an alias of an entity in important fields and/or with great frequency in a document may be indicative of association of the entity to the document. Also, for example, an association between a document and an entity may be based on presence of additional and/or alternative properties of an entity such as date of birth, place of birth, height, weight, population, geographic location(s), type of entity (e.g., person, actor, location, business, university), etc. Also, for example, an association between a document and an entity may be identified based on association between that entity and other entities in the document. For example, an entity may be associated with one or more additional entities based on co-occurrence of those entities in documents of a corpus of documents and/or based on other identified link such as hyperlinks between a document describing the entity and another document describing one of the additional entities. For example, a document may contain the term “Sting” and may also contain the term “wrestler”. Based on an association between the entity associated with the wrestler Sting and the entity representing the concept of wrestling, the entity associated with the wrestler Sting may be identified as associated with the document.

One or more of the documents identified in step 300 may be associated with one or more entities. In some implementations some of the documents identified in step 300 may not be associated with any entities. In some implementations all entities associated with a document may be identified. In some implementations only a certain portion of the entities associated with a document may be identified. For example, in some implementations the entities associated with a document may be ranked and only one or more of the top ranked entities may be identified. In some implementations only those entities that satisfy an association threshold with the identified search result documents are identified. For example, in some implementations only those entities that are associated with a threshold number of the search result documents are identified. Also, for example, in some implementations only those entities that occur in at least a threshold percentage of search result documents are identified.

At step 315 one or more of the entities is associated with the query identified at step 300. In some implementations a given entity is associated with the query if it can be considered an interpretation of the query. Determination of whether a given entity is an interpretation of a query may be based on one or more properties of the entity. In some implementations the properties may be identified from one or more databases such as entity properties database 105.

In some implementations a given entity may be determined to be associated with the query if it can be considered to satisfy one or more conditions. For example, a given entity may be determined to be associated with the query if it can be considered to satisfy one or more of the following conditions:
a. The query exactly matches one trusted alias of the entity (e.g., query “sting” matches a trusted name for the entity associated with Steven Borden).
b. The query contains only one trusted alias of the entity and additional terms from a list of stop terms and/or stop phrases (e.g., “who is”, “the”, “an”).
c. The query contains only a trusted alias of the entity and a suffix that represents a property of the entity such as a “type” of the entity (e.g., “sting wrestler”, “sting musician”, or “washington state”).
d. The query contains one trusted alias of the entity and additionally, one of the top search result documents for the query is a reference page for that entity. Top search results may include, for example, the top X search results, the first page of search results, only the top search result, etc. The reference page for that entity may be a webpage that is referenced as a reference page for the entity in a database such as entity properties database 105. In some implementations the reference page for the entity may be a webpage in an online resource (e.g., one or more white listed resource websites) that is specifically directed toward that entity.
e. The query contains only the name of two entities and/or stop terms or stop phrases, wherein one of the two entities is “implied” by the other entity. For example:
   i. The first entity is a location and the name of one of its containing locations is the second entity (e.g., “lake tahoe ca”)
   ii. The first entity is a media piece such as a book and the second entity is a creator of the media piece such as an author (e.g., “da vinci code dan brown”).

In some implementations additional and/or alternative conditions may be utilized in determining whether a given entity is an interpretation of a query. In some implementations some stemming, spell correction, and/or other textual modification of a received query may be performed prior to determining whether a given entity is an interpretation of a query. For example, a received query of “da venci code dan brown” may be spell corrected to “da vinci code dan brown”.

At step 320 a ranking is determined for each of the entities associated with the query at step 315. In some implementations the ranking is based on an entity score determined for each of the identified entities. In some implementations the entity score for a given entity is based on a relationship between the query identified at step 300 and the search result documents associated with the given entity. For example, the entity score for a given entity may be based on a query to document relevance scores for each of the one or more search result documents associated with the given entity. In some implementations the query to document relevance score for a given document may be based on one or more signals such as those described herein with respect to the search system 115. Each signal may provide information about the document itself and/or the relationship between the document and the query. One example signal for a document for a query is the fraction of clicks for that query going to that document. Another example signal is a measure of the overall quality of the document. In some implementations the query to document score may be identified by the search system 115.

The query to document relevance scores for each of the documents associated with the entity may be utilized in determining a score for the entity. For example, an entity E₁ may be associated with search result documents D₁,D₂, and D₃ and the entity score for entity E₁ may be based on scores related to relevance of the search result documents D₁,D₂, and D₃ to the query. For example, the entity score for entity E₁ may be based on summing the scores for the documents and/or averaging the scores for the documents.

In some implementations the entity score for an entity is additionally and/or alternatively based on a relationship between the entity and the search result documents associated with the entity. For example, in some implementations the query to entity association system 120 may identify a relationship between the entity and the search result documents associated with the entity based on a database of documents and associated entities such as document and entity association database 110. For example, for each of the identified documents, the document and entity association database 110 may be consulted to identify a ranking for one or more entities associated with the document. For example, the document and entity association database 110 may include entity to document relevance scores for each entity in each document. Each entity to document relevance score for a given entity in a given document may be indicative of the importance of the given entity in the given document.

For example, in some implementations entity to document relevance score may be based on frequency of appearance, location of appearance, and/or formatting applied to one or more occurrences of the entity in the document; frequency of appearance, location of appearance, and/or formatting applied to one or more properties of the entity in the document. For example, an entity to document relevance score may be based on an importance of one or more alias of the entity in the document. Also, for example, appearance of an alias of an entity in important fields and/or with great frequency in a document may provide a score more indicative of importance of that entity in that document than if the entity occurred only in un-important fields and/or with little frequency. Also, for example, a score for an entity in a document may be based on presence of additional and/or alternative properties of the entity such as date of birth, place of birth, height, weight, population, geographic location(s), type of entity (e.g., person, actor, location, business, university), etc.

In some implementations the query to entity association system 120 may identify a ranking between the entity and the search result documents associated with the entity without accessing a database of documents and associated entities. For example, in some implementations an entity to document relevance score may be determined by the query to entity association system 120 and based on frequency of appearance, location of appearance, and/or formatting applied to one or more occurrences of the entity in the document; frequency of appearance, location of appearance, and/or formatting applied to one or more properties of the entity in the document; and/or other factors.

Additional and/or alternative factors may be considered in determining an entity to document relevance score. For example, the query to entity association system 120 may obtain data that characterizes portions of the text of the documents as boilerplate content, (e.g., content that is reused in multiple resources). If the occurrence of the entity is in a portion of the text that has been characterized as boilerplate, the weight of the occurrence in that document can be decreased (e.g., so that an occurrence in a portion of the text that has been characterized as boilerplate has a lower weight than an occurrence in a portion of the text not characterized as boilerplate). Also, for example, in some implementations, the system also considers occurrences of aliases for the entity that are not in the text of the resource. For example, the system can consider how frequently an alias for the entity occurs in the resource locator (e.g., a Uniform Resource Locator (URL)) for the resource, how frequently an alias for the entity appears in anchor text for links pointing to the document, and/or how frequently an alias for the entity appears in the text of search queries submitted to a search engine that resulted in a user navigating to the document by selecting a search result identifying the document. One or more of these occurrences can be given an increased weight, e.g., so that they have a greater weight than occurrences in the body of the resource.

Another example factor that can be considered is the connectedness of the entity to the other entities referred to by aliases in the resource. For example, a connectedness score for an entity can be computed based on link scores between the entity and each other entity referred to in the resource. For example, link scores between entities may be obtained from a database such as entity properties database 105.

In some implementations, once the entity to document relevance score for each entity in a given document have been determined, the entity to document relevance scores across the entities may be normalized (e.g., so that the entity to document relevance scores are reduced if there many different entities referenced in the resource).

The entity to document relevance scores for each of the documents associated with the entity may be utilized in determining a score for the entity. For example, an entity E₁ may be associated with search result documents D₁, D₂, and D₃ and the entity score for entity E₁ may be based on scores related to the relevance of the search result documents D₁, D₂, and D₃ to the entity. For example, the entity to document relevance score for entity E₁ may be based on summing the scores for the documents and/or averaging the scores for the documents. In some implementations the entity to document relevance scores for a given entity may be a number from zero to one.

In some implementations the entity score for an entity is based on a relationship between the query and the search result documents associated with the entity and is based on a relationship between the entity and the search result documents associated with the entity. For example, in some implementations the entity score for an entity is obtained by summing the product of the query to document relevance score times the entity to document relevance scores over all documents containing the entity.

For example, for an entity E₁ may be associated with search result documents D₁,D₂, and D₃ and query to document relevance scores of QD₁,QD₂, and QD₃ may be obtained for those search result documents and entity to document relevance scores of ED₁,ED₂, and ED₃ may be obtained for those search result documents. The entity score for the entity E₁ may be (QD₁*ED₁)+(QD₂*ED₂)+(QD₃*ED₃).

Additional and/or alternative calculations of an entity score may be utilized. In some implementations those additional and/or alternative calculations may be based on both the query to document relevance scores and the entity to document relevance scores over one or more documents responsive to the query identified at step 300.

In some implementations a highest ranked entity of the entities for a query may be identified as a dominant entity for that query when the ranking of the highest ranked entity satisfies a threshold, such as a threshold relative to the ranking of a lower ranked entity of the entities. For example, if an entity score for a highest ranked entity of the entities satisfies a threshold relative to the ranking of a lower ranked entity of the entities (e.g., the second highest ranked entity), then it may be identified as a dominant entity for that query.

In some implementations one or more entities associated with the query at step 315 may be removed from being associated with the query based on the ranking determined at step 320. For example, in implementations where a score is assigned to the entities, an entity may be removed from being associated with the query when the score for that entity fails to satisfy a threshold. Also, for example, in some implementations only the top X ranked entities may be associated with a given query (where X represents an integer), wherein those entities that are not in the top X ranked entities are removed from being associated with the query.

In some implementations the association between query received at step 300 and the entities associated with the query at step 315 may be stored in a database such as query to entity association database 125. In some implementations whether an entity is associated with a given query may also be based on the ranking for that entity as determined in step 320. For example, in some implementations even though an entity may be considered a valid interpretation of a query, it may not be stored in the query to entity association database 125 if its ranking fails to satisfy a threshold ranking (e.g., it does not have a score that satisfies a threshold, it is ranked too low relative to other entities).

In some implementation the ranking for each of the entities determined at step 320 may also be stored in a database such as query to entity association database 125. For example, in implementations where entity scores are determined for each of the entities associated with the query, the entity score for each entity for a given query may be stored in the database. For example, for the query “sting” the entity associated with the wrestler may have a first score and the entity associated with the singer may have a second score. Also, for example, each entity for a given query may be identified as the primary, secondary, tertiary, etc. entity for the given query in the database. For example, for the query “sting” the entity associated with the wrestler may be identified as the secondary entity and the entity associated with the singer may be identified as the primary entity.

In some implementations a reduced mapping between queries and entities may be stored in a database such as query to entity association database 125 by filtering out any queries that do not have any entities associated therewith (or only have entities that fail to satisfy a threshold ranking). Any stored data may optionally be associated with a corresponding query in the database for future retrieval in response to a future search request for the query.

FIG. 4 is a flow chart illustrating an example method of identifying one or more entities associated with a query and providing one or more entity summaries for the query. Other implementations may perform the steps in a different order, omit certain steps, and/or perform different and/or additional steps than those illustrated in FIG. 4. For convenience, aspects of FIG. 4 will be described with reference to a system of one or more computers that perform the process. The system may include, for example, the search system 115 and/or the query to entity association system 120 of FIG. 1.

At step 400, a query is received. In some implementations the search system 115 may receive the query. In some implementations the query to entity association system 120 may receive the query. In some implementations the query may be a query submitted by a user.

At step 405, one or more entities associated with the query are identified. In some implementations the entities may be identified from query to entity association database 125. In some implementations the entities may be identified via query to entity association system 120 performing one or more steps of the method of FIG. 3 such as steps 305-315.

At step 410, one or more entity summaries are provided to display in combination with search results for the query. Each entity summary includes information about a single of the entities. For example, entity summaries such as those illustrated in FIGS. 2A-2C may be provided to display in combination with search results that are responsive to the query. In some implementations the information of the one or more entity summaries may be obtained from the query to entity association database 125 and/or the entity properties database 105. In some implementations one or more of the entity summaries may be identified as a dominant entity summary. In some implementations identification as a dominant entity summary may be based on a ranking such as a ranking specific to the entity of the entity summary for the given query. Such a ranking may be obtained from the query to entity association database 125 and, as discussed herein, may optionally be modified based on provided search results responsive to the query.

FIG. 5 is a flow chart illustrating an example method of identifying one or more entities associated with a query and providing a query suggestion for a received query based on the one or more entities associated with the query. For convenience, aspects of FIG. 5 will be described with reference to a system of one or more computers that perform the process. The system may include, for example, the query suggestion system 135 and/or the query to entity association system 120 of FIG. 1.

At step 500 a query is received. For example, with reference to FIG. 6, the query “washington” may be received in the search field 600. In some implementations the search system 115 may receive the query. In some implementations the query suggestion system 135 may receive the query. In some implementations the query may be a query submitted by a user. In some implementations the query may be a query from a log of queries, such as a log of past user queries and/or automatically generated queries. In some implementations the automatically generated queries may be generated based on identifying a trusted name of each of one or more entities, and combining the trusted name with an additional property of the entity such as a type of the entity, and or another linked entity. In some implementations the query may be a partial query.

At step 505 one or more entities associated with the query may be identified. In some implementations the entities may be identified from query to entity association database 125. In some implementations the entities may be identified via query to entity association system 120 performing one or more steps of the method of FIG. 3 such as steps 305-315.

At step 510 at least one query suggestion is provided for the query, wherein the query suggestion includes an entity descriptor based on one of the entities associated with the query. For example, with reference to FIG. 6, for the query “washington”, multiple query suggestions are provided in a cascaded drop down menu 620 below the search field. The query suggestions include: a first query suggestion of “Washington—U.S. State in Pacific Northwest” that includes the descriptor “U.S. State in Pacific Northwest”; a second query suggestion of “Washington dc—District of Columbia” that includes the descriptor “District of Columbia”; a third query suggestion of “Washington (university of)” that includes the descriptor “university of”; and a fourth query suggestion of “George Washington—1^{st} President” that includes the descriptor “1^{st} President”.

In some implementations a ranking of the entities associated with the query may also be identified. In some implementations the rankings may be identified from query to entity association database 125. In some implementations the entities may be identified via query to entity association system 120 performing one or more steps of the method of FIG. 3 such as step 320. In some implementations the rankings of the entities may be utilized to rank the query suggestions. For example, for a query of “sting” a first query suggestion of “sting wrestler” may be provided for a first entity that has a first ranking for the query “sting” and a second query suggestion of “sting musician” may be provided for a second entity that has a second ranking for the query “sting”. The first ranking may be more indicative of association of the entity to the query “sting” than the second ranking. The first ranking and/or second ranking may be utilized as a component of and/or the ranking for the query suggestions “sting musician” and “sting wrestler”, thereby causing “sting musician” to be displayed higher in a listing than “sting wrestler”. Also, for example, rankings associated with the query “washington” for the entities in FIG. 6 may be utilized in determining which autocomplete query suggestions are displayed and/or in which order the autocomplete query suggestions are displayed.

The provided entity descriptor identifies a particular entity associated with the autocomplete query suggestion (as identified in step 505) to assist in disambiguating the query “washington”. As discussed herein, in some implementations the descriptor may be based on identification of one or more properties associated with the entities associated with the query “washington”. In some implementations the entity descriptor may be included in a submitted search query. For example, selecting “washington (university of)” may cause submission of a search query for “university of washington”. In some implementations the submitted search query may omit the entity descriptor. For example, selecting “washington (university of)” may cause submission of a search query for “washington college seattle”.

FIG. 6 illustrates determining entities for the actual entered query “washington” and annotating that query and autocomplete suggestions based on that query (washington dc, George washington). In some implementations entities may be determined for one or more autocomplete suggestions for an entered query. For example, assume a user entered “washingt” in search field 600. At step 505 a plurality of entities may be identified based on the term “washingt” by identifying an autocomplete suggestion for that word such as “washington”, then identifying entities associated with that autocomplete suggestion. The autocomplete suggestion “washington” may then be annotated with disambiguating information based on identification of the multiple entities. For example, entity descriptors may be provided with “washington” to create query suggestions of “washington, district of Columbia”, “washington, state in Pacific Northwest.”

Alternative formats of presenting query suggestions may be provided. For example, as discussed herein query suggestions for a submitted query may be provided in combination with search results for the submitted query.

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface input devices 722, user interface output devices 720, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to associate a query with at least one entity; provide one or more entity summaries for a query; and/or identify a query suggestion based on a query to entity association.

These software modules are generally executed by processor 714 alone or in combination with other processors. Memory 725 used in the storage subsystem can include a number of memories including a main random access memory (RAM) 730 for storage of instructions and data during program execution and a read only memory (ROM) 732 in which fixed instructions are stored. A file storage subsystem 724 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 724 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

While several inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1. A computer implemented method, comprising:
receiving a query;
identifying a plurality of entities associated with the query based on a query to entity mapping;
providing a plurality of query suggestions for the query in response to entry of the query by a user in a search field, each of the query suggestions based on said query and including an entity descriptor based on a respective one of the entities associated with the query;
identifying, for a given query suggestion of the query suggestions, a search query to be submitted in response to selection of the given query suggestion by the user, wherein the search query includes first terms and the entity descriptor of the given query suggestion includes at least one second term that is not included in the first terms of the search query;
receiving a selection by the user of the given query suggestion from the plurality of query suggestions; and
submitting the search query in response to the selection by the user of the given query suggestion.

2. The method of claim 1, further comprising:
identifying a ranking of the entities for the query; and
ranking the query suggestions based on the ranking of the entities on which the entity descriptors of the query suggestions are based.

3. The method of claim 2, wherein the ranking of each of the entities for the query is based on relationship between the query and search result documents responsive to the query and associated with the entity, and based on the relationship between the entity and the search result documents associated with the entity.

4. The method of claim 1, wherein the entity descriptor includes at least one property of the entity.

5. The method of claim 4, wherein the at least one property of the entity includes an entity type of the entity.

6. The method of claim 4, wherein the at least one property of the entity includes a trusted name of the entity.

7. The method of claim 4, wherein the at least one property of the entity includes an image of the entity.

8. (canceled)

9. (canceled)

10. The method of claim 1, wherein the search query includes at least one property of the entity.

11. The method of claim 1, wherein the query is a partial query.

12. A system including memory and one or more processors operable to execute instructions stored in the memory, comprising instructions to:
receive a query;
identify a plurality of entities associated with the query based on a query to entity mapping;
provide a plurality of query suggestions for the query in response to entry of the query by a user in a search field, each of the query suggestions based on said query and including an entity descriptor based on a respective one of the entities associated with the query;
identify, for a given query suggestion of the query suggestions, a search query to be submitted in response to selection of the given query suggestion by the user, wherein the search query includes first terms and the entity descriptor of the given query suggestion includes at least one second term that is not included in the first terms of the search query;
receive a selection by the user of the given query suggestion from the plurality of query suggestions; and
submit the search query in response to the selection by the user of the given query suggestion.

13. The system of claim 12, wherein the instructions further include instructions to:
identify a ranking of the entities for the query; and
rank the query suggestions based on the ranking of the entities on which the entity descriptors of the query suggestions are based.

14. The system of claim 13, wherein the ranking of each of the entities for the query is based on relationship between the query and search result documents responsive to the query and associated with the entity, and based on the relationship between the entity and the search result documents associated with the entity.

15. The system of claim 12, wherein the entity descriptor includes at least one property of the entity.

16. The system of claim 15, wherein the at least one property of the entity includes an entity type of the entity.

17. The system of claim 15, wherein the at least one property of the entity includes a trusted name of the entity.

18. The system of claim 15, wherein the at least one property of the entity includes an image of the entity.

19. (canceled)

20. (canceled)

21. The system of claim 12, wherein the search query includes at least one property of the entity.

22. The system of claim 12, wherein the query is a partial query.

23. A non-transitory computer readable storage medium storing computer instructions executable by a processor to perform a method comprising:
receiving a query;
identifying a plurality of entities associated with the query based on a query to entity mapping;
providing a plurality of query suggestions for the query in response to entry of the query by a user in a search field, each of the query suggestions based on said query and including an entity descriptor based on a respective one of the entities associated with the query;
identifying, for a given query suggestion of the query suggestions, a search query to be submitted in response to selection of the given query suggestion by the user, wherein the search query includes first terms and the entity descriptor of the given query suggestion includes at least one second term that is not included in the first terms of the search query;
receiving a selection by the user of the given query suggestion from the plurality of query suggestions; and
submitting the search query in response to the selection by the user of the given query suggestion.

24. The method of claim 11, wherein the first terms of the search query include at least one term that includes characters of the partial query.

25. The method of claim 1, wherein the search query to be submitted in response to selection of the given query suggestion is an entity search query associated with the entity on which the entity descriptor of the given query suggestion is based.

26. The method of claim 3, wherein the relationship between the entity and the search result documents associated with the entity is based on a plurality of entity relevance scores, each of the entity relevance scores having a magnitude indicative of the importance of the entity in a respective of the search result documents.
